(19) United States
(12) Patent Application Publication
(10) Pub. No.: US 2012/0103858 A1
(43) Pub. Date: May 3, 2012

(54) METHOD FOR PRODUCING A PACKAGING CONTAINER AND PACKAGING CONTAINER

(75) Inventor: Rene Schmidt, Kamenz (DE)

(73) Assignee: OPTIPACK GMBH, Aretsried (DE)

(21) Appl. No.: 13/248,768

(22) Filed: Sep. 29, 2011

(30) Foreign Application Priority Data
Sep. 30, 2010 (EP) 10 012 417.1

(51) Int. Cl. B65D 85/00; B29C 51/00; B29C 65/48; B29C 51/08; B23P 19/04; B29C 47/08

(52) U.S. Cl. 206/524.6; 29/428; 264/3.3; 156/244.11

(57) ABSTRACT

Embodiments of the invention concern a method for producing a packaging container (50), in which a synthetic raw material is melted and extruded to obtain a plastic film (30, 40), which is subsequently processed in a forming process on to the packaging container. At least a portion of the plastic raw material has a propellant added prior to or during the extrusion process in such a way that it leads to the expansion of the extrudate that contains the propellant upon exit from the extrusion die, occasionally accompanying the release of a propellant gas. Embodiments of the invention also concern a packaging container (50) that is produced according to this method which has a container base (56) and a lateral boundary of the container that indicates the container wall (52) which constitutes the shell of the container (54), whereby the container wall is at least partially created by a foamed plastic material.

### CROSS REFERENCE TO RELATED APPLICATIONS

The present application claims international priority under 35 U.S.C. §119 to co-pending European Patent Application No 10012417.1 originally filed Sep. 30, 2010, the disclosure of which is hereby incorporated by reference in its entirety for all purposes except for those sections, if any, that are inconsistent with this specification.

### BACKGROUND

Embodiments of the invention concern a method for producing a packaging container, in which a plastic raw material is melted and extruded to obtain a plastic film, which is subsequently processed in a forming process on to the packaging container. At least a portion of the plastic raw material has a propellant added prior to or during the extrusion process in such a manner that it leads to the expansion of the extrudate that contains the propellant upon exit from the extrusion die, occasionally accompanying the release of a propellant gas. Embodiments of the invention also concern a packaging container that is produced according to this method.

Extrusion methods for the production of packaging containers such as, for example, plastic bottles or plastic cups are known. Generally plastic raw products in a granulate form, in particular thermoplastic polymers such as polystyrene are melted down using heat and internal friction and are pressed through an extrusion die using pressure, whereby the extrusion profile of the extruded plastic element is dependent on the transverse section of the extrusion die.

For example a pipe-shaped plastic film can be achieved with a ring-shaped extrusion die, which in a further production phase can be pressed onto a mold wall when surrounded by a mold and upon application of compressed air. Hollow bodies such as plastic bottles and cups can easily be produced with the assistance of such extrusion blow molding. By use of a slit-shaped extrusion die, it is possible to produce a flat plastic film that can then, for example, be further processed through thermoforming into a packaging container. In this context, when speaking of plastic films that are produced according to the extrusion method, it is generally understood that one is speaking of films having thicknesses of up to 1.5 mm.

It has been shown through the aforementioned method that the plastic film needs to have a certain minimum thickness, so that the packaging container that is produced from the film in a molding process has sufficient solidity; in particular the packaging container must be sufficiently resistant for example in the case of packaging containers used to contain foodstuffs such as dairy or yoghurt, to protect against outside forces such as those occurring during shipment as well as tightly containing the foodstuff. For yoghurt cups, the total thickness of the film that is used for the production of the packaging container is generally approximately 0.6 mm. The plastic material that is used for this purpose does however make the foodstuff container heavy, bringing along with it high transportation and production costs. A more limited wall thickness is furthermore preferable due to lesser use of plastic as well as for reasons related to disposal technology. The use of a thinner plastic film, for example in the production of yoghurt cups, has however led to cup solidity problems, especially in the area around the cup seal edge.

Given this problem with the state of the art, the purpose of embodiments of the invention is to increase the solidity of packaging containers.

### BRIEF DESCRIPTION OF DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1, a schematic sketch of the method according to embodiments of the invention for the production of a packaging container.

FIG. 2a, a schematic view of the layering of a three-layered plastic film following extrusion or alternatively of the container wall of a packaging container that is produced according to embodiments of the invention having a first layered lay-out.

FIG. 2b, a schematic view of the layering of a three-layered plastic film following extrusion or alternatively of the container wall of a packaging container that is produced according to embodiments of the invention having a second layered lay-out.

FIG. 3a, a side view of a packaging container according to embodiments of the invention.

FIG. 3b, a fold-out sheet for the creation of a sleeve that can be applied to the packaging container according to embodiments of the invention.

FIG. 3c, the packaging container according to embodiments of the invention from FIG. 3a to which the sleeve from FIG. 3b is applied.

### DETAILED DESCRIPTION OF EMBODIMENTS

This purpose is solved according to embodiments of the invention by means of a further improvement of the aforementioned production method, which is largely characterized by at least one portion of the plastic raw material having a propellant added prior to or during the extrusion process in such a way that it leads to the expansion of the extrudate that contains the propellant upon exit from the extrusion die, occasionally accompanied by the release of a propellant gas.

Embodiments of the invention trace back to the recognition that, when one maintains the same quantity of plastic raw material, it is possible to produce a more solid plastic container when at least a portion of the plastic film which is used to form the container wall, is constituted in the form of a “foam film” that is made up of foamed plastic material. It has in fact been shown that a foam film demonstrates static properties which are comparable to those of a crane boom, whose lateral and longitudinal struts act to solidify the whole structure, due to its foamed plastic structure having honeycomb wall structures between the individual pores of the foam.

It is preferable that the plastic raw material features polyethylene terephthalate (PET). It has indeed been shown that, from the point of view of disposal technology, it is preferable to use polyethylene terephthalate in place of polystyrene in the production of one-way packaging. PET does however have a higher density than polystyrene, which is the reason why packaging containers made out of PET are heavier and more costly in production than polystyrene packaging containers made in the same shape and using the same wall thickness. It is however possible to produce a solid packaging container made out of PET making a lesser use of material, insofar as a container wall made of PET that is foamed in at least partial areas which are produced at least in part of foamed PET film, which ensures the needed solidity, while contemporaneously the weight of the packaging container is reduced under the use of at least partial foaming when using the same total film thickness.

The propellant, which is preferably a stoichiometric mixture containing citric acid and/or sodium hydrogen carbonate, can be added to the plastic raw material in batch form prior to and/or during the extrusion phase for this purpose. Subsequently, by the action of heat in the extruder, a propellant gas that brings about the melting of the plastic is released through a chemical procedure, which upon emission from the extrusion die ensures the expansion of the extrudate upon discharge from the extrusion die, due to the changed pressure conditions.

It has thereby been shown to be particularly appropriate to produce a multi-layered, preferably three-layered, plastic film. The properties of the individual layers of the container wall can thereby be tuned for the application purpose.

Multi-layered plastic films can in particular be produced through a co-extrusion process, whereby multiple plastic melts of the same and/or different types are joined upon or shortly before leaving the extrusion die. This allows the production of a plastic film with properties that are tuned for the application purpose. For example it is possible to lay out a packaging container in such a manner that the inner-laying layer, which is to say a layer that makes up the inside surface of the packaging container, is produced in an especially diffusion-tight manner and the outer-laying layer is set up to be particularly resistant to mechanical forces. In particular the inner-laying layer of a packaging container, for example a yoghurt cup should be smooth so as to facilitate the spooning out of the container and to prevent the clinging of foodstuff remains in/on surface irregularities.

A packaging container according to embodiments of the invention is produced in a forming process following the extrusion or co-extrusion of the at least partially foamed plastic film. The forming process preferably features a deep-drawing process or alternatively thermoforming process. The plastic film is fed into a thermoforming device, whereby the still warm and thereby pliable film can immediately thereafter be fed into the extrusion process of a thermoforming device or a cooled film can additionally be heated prior to the thermoforming process. The warm film is then quickly applied to the cooled wall of a forming device and thereby permanently takes on its form during the cooling phase. In a further step, the created plastic form can be punched out.

An extrusion blow molding procedure is possible, by which the packaging container is produced from the plastic film with the assistance of an extrusion blow mold, where required immediately after the extrusion process. A ring-shaped extrusion die and therewith a pipe-shaped extrudate are however preferably available for this process.

The solidity of the containers that are produced according to embodiments of the invention method can be further increased with a decrease in the use of plastic, when subsequent to the forming process a sleeve is wrapped around the ready formed packaging container, in such a way that the sleeve is at least partially laid up against and reinforcing an outer surface of the container wall. The sleeve can enclose the container in a band-like manner and thereby reinforce the packaging container wall. Through the use, for example, of a sleeve made of paper, the container contents are kept warm or alternatively cold for a longer period insofar as a heat exchange through the container wall is slowed throughout. Furthermore the user of the container does not burn his fingers as quickly in the case of the container being filled with hot contents, insofar as they only touch the sleeve made out of paper.

It is advantageous from an environmental point of view when the sleeve is sealed or glued to the container wall in a removable manner. The user can then separately dispose of the sleeve, generally made of paper, and of the plastic container. It is possible to provide for a tear line on the sleeve for this purpose, along which the sleeve is separated and can be removed.

Furthermore a bottom part is attached in a practical manner to the container base and preferably attached to the sleeve by the flanging of a lower edge of the sleeve. The bottom part can alternatively or additionally be sealed or glued to the container base. The bottom part can be stamped or cut out from a flat material web and in the same manner as the sleeve, can be made of printed and/or coated paper or cardboard.

Embodiments of the invention furthermore concern a packaging container that is produced according to the process of embodiments of the invention with a container wall featuring a container base and a container creating lateral boundary of the container shell. The container wall that is created out of the extruded plastic film is at least partially created from a foamed plastic material.

The plastic material preferably features polyethylene terephthalate (PET). As described above, it is possible to produce a solid packaging container out of PET while using a lesser amount of material, when the container wall is at least partially produced using foamed PET-film. It is thus that, through the use of at least partial foaming, the required stability can be ensured while simultaneously the weight of the packaging container can be held down when using the same film thickness. At the same time the use of polyethylene terephthalate is to be preferred over that of polystyrene for reasons linked to disposal technology.

A packaging container that is produced according to embodiments of the invention can better be tuned for the application purpose, when using at least partially multi-layered, preferably three-layered container wall construction. It is preferable that a multi-layer plastic film is produced through a co-extrusion process.

One of the internal layers of the container wall, which is to say, a layer that lies between two other layers of the container wall, will preferably feature a lesser geometric density than that of the layers surrounding the internal layer, in particular than the outer surface layer of the container wall. The outer surface layers are generally more heavily stressed than internal layers of the container wall, so that it is practical that plastic layers having a higher density, which are generally more stress resistant than plastic layers that have lesser density, are on the outside surface.

It has been shown to be especially useful when at least one internal layer of the container wall is at least partially made up of a foamed plastic material and it is preferred that the top surface layers of the container wall are made up of non-foamed plastic material. The foaming of one of the internal layers of the plastic film can be ensured through the addition prior to and/or during the extrusion process of a propellant to the plastic raw material used to create this layer. When the internal layer and the layers that surround the internal layer or alternatively the outer surface layers are made using the same plastic raw material, whereby a propellant is added to the plastic raw material that is used to create the internal layer, then the internal layer will feature a lesser geometric density after extrusion than that of the layers surrounding the internal layer, or alternatively than the outer surface layers of the container wall. When the film is three-layered, then the packaging container that is made of the film shows a sandwich-like container wall structure where a foamed internal film layer is surrounded by non-foamed outer surface layers that thereby demonstrate a higher density. A further solidification of the container wall results from this “sandwich effect”. Furthermore, a packaging container that is made using such a film demonstrates a smooth outer surface, but is recognizably lighter than a container that is fully plastic having the same wall thickness due to the foamed “middle layer”.

The thickness of the foamed layer is preferably between 50% and 90%, in particular 80% of the total thickness of the container wall. Under such conditions it is possible to produce a solid packaging container using a limited amount of material.

It has been demonstrated to be very useful in the framework of embodiments of the invention when an internal layer of the container wall features a thickness in the range of 0.1-1 mm, preferably 0.4-0.6 mm, most preferably 0.48 mm and that both of the outer surface layers of the container wall each feature thicknesses in the range of 0.01-0.1 mm, preferably 0.04-0.08 mm, most preferably 0.06 mm. These layer thicknesses are especially appropriate for the production of a plastic cup and maintain the required solidity.

A packaging container according to embodiments of the invention can be produced in an especially economical manner, when all of the layers of the container wall are at least partially made of PET. In this case the manufacturer then only needs to prepare one type of plastic raw material for production.

A foamed layer of the container wall preferably features a geometric density in the range of 0.5-1.2 g/cm3, preferably 0.8-1 g/cm3. It has in fact been determined that a PET packaging container with a three-layered container wall, whose middle layer makes up approximately 80% of the total thickness and features the described geometric density following the foaming, is particularly light and at the same time sufficiently solid. Non-foamed PET features a density of approximately 1.33 g/cm3.

A packaging container according to embodiments of the invention is preferably a plastic cup, and is preferably used to contain dairy products, in particular to contain yoghurt.

The container shell of the packaging container can feature a tear line of any shape, in particular angular, round or oval, that runs approximately parallel to the container base. In the case where the packaging container is a plastic cup, it is preferable that the container shell features a tear line that runs parallel to the container base that is of a round shape. The container shell can then at least partially be in a (pitch) cylindrical shell and/or a frustoconical shell shape, whereby the spooning out of the cup is facilitated. Furthermore a rotationally symmetrical packaging container can be very easily and economically produced.

The container wall opposite to the container base side of the container shell, preferably features a seal edge that runs approximately parallel to the container base. In particular, it is important to have a solid execution of the container wall in the area of the seal edge, insofar as the seal edge is exposed to especially great mechanical forces. It is particularly preferable that the container shell in the area of the seal edge is at least partially made of a foamed plastic material.

In an alternative embodiment, the packaging container can feature polystyrene (PS) or polypropylene (PP) as plastic material. Both of these plastic materials have a lesser density than PET, so that a container that is fully made out of these plastic materials is especially light. A packaging container that is made out of PS or PP preferably features a three-layered container wall with foamed middle layer, whereby the thickness of the middle layer is approximately 63% of the total thickness of the container wall and the thickness of both of the outer layers can both be approximately 18% each. The ratio of foamed quantity of plastic material and non-foamed plastic material can therefore be lesser with the use of PP or PS than when using PET, when one is to produce containers of the same shape and weight.

It has been demonstrated that, when making a particularly limited use of plastic material while at the same time maintaining a high level of solidity of the container, it is advantageous to use a reinforcing sleeve that is at least partially placed on the outside surface of the container shell to give an additional reinforcement to the container wall. The sleeve will be placed on one of the outer surfaces of the container subsequent to the forming process and should the occasion arise will be bound to the container wall in that position by gluing or sealing.

The sleeve preferably extends itself outward from the container base, in the direction of the seal edge of the container and at least partially surrounds the container shell in a pipe-like manner. The shape of the sleeve is therefore adapted to the shape of the container shell. A sleeve that is to be applied to a container in the shape of a cone-shaped cup can for example be tapered towards the container base. Other containers and sleeve forms are just as readily conceivable.

Furthermore the container can be solidified through the use of a base part, which reinforces the container base that is preferably linked to the sleeve, and at least partially laid up against the outer surface of the container base.

In a particularly preferred embodiment of the invention, the sleeve and/or the bottom part features preferably coated and/or printed cardboard or paper material. Preferably the sleeve is in the most part fully made out of paper and can be printed and/or coated on one or both sides. The coating can be set out to, for example, protect the printing from being rubbed off or to protect the paper from humidity.

Embodiments of the invention will be explained in the following description by way of example with reference to the illustrations.

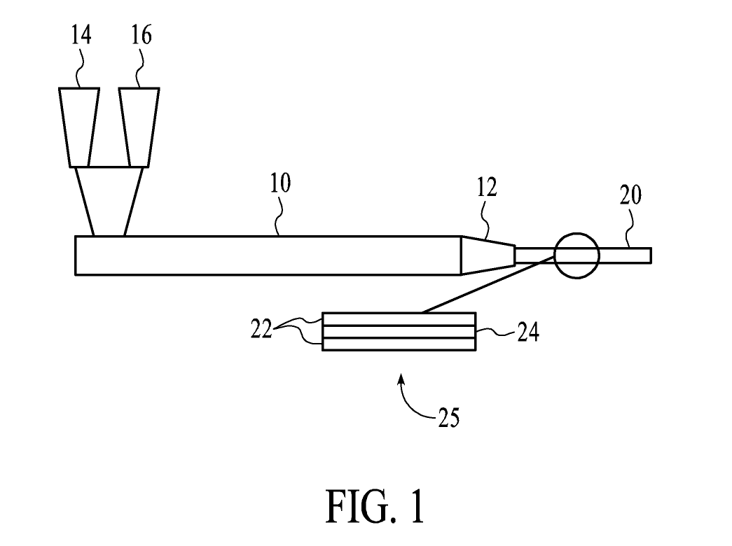

In FIG. 1 there is a schematic depiction of an extruder 10 with an extrusion die 12 on its forwards end and two feeder containers 14 and 16 for the supply of the raw materials. The feeder container 14 can supply the plastic raw material, for example in the form of PET granulate, the feeder container 16 can work for the supply of a foamed component, for example in the form of a mixture of PET granulate with a propellant. The propellant can, for example, contain citric acid.

The PET granulate is melted in the extruder 10 through heating and internal friction and pressed through the extrusion die 12 to create the plastic film 20. The plastic film will be further processed in a subsequent process phase to create a packaging container according to embodiments of the invention.

It is possible to obtain a multi-layer plastic film 20 through a co-extrusion process, whereby the various plastic raw materials are joined during or shortly after the exit from the extrusion die 12. It is possible, for example, that a first plastic material can contain a propellant, which leads to the expansion of the extrudate containing the propellant upon its exit from the extrusion die, occasionally with release of a propellant gas. With the use of an appropriate extrusion die, the foamed plastic material can create the internal layer 24 of a three-layered plastic film 25. The outer layers 22 of the three-layered plastic film 25 can be extruded using a plastic raw material without the addition of a propellant which is thereby non-foamed.

A packaging container according to embodiments of the invention is created from the three-layered film 25 in a forming process, which can feature a thermoforming process.

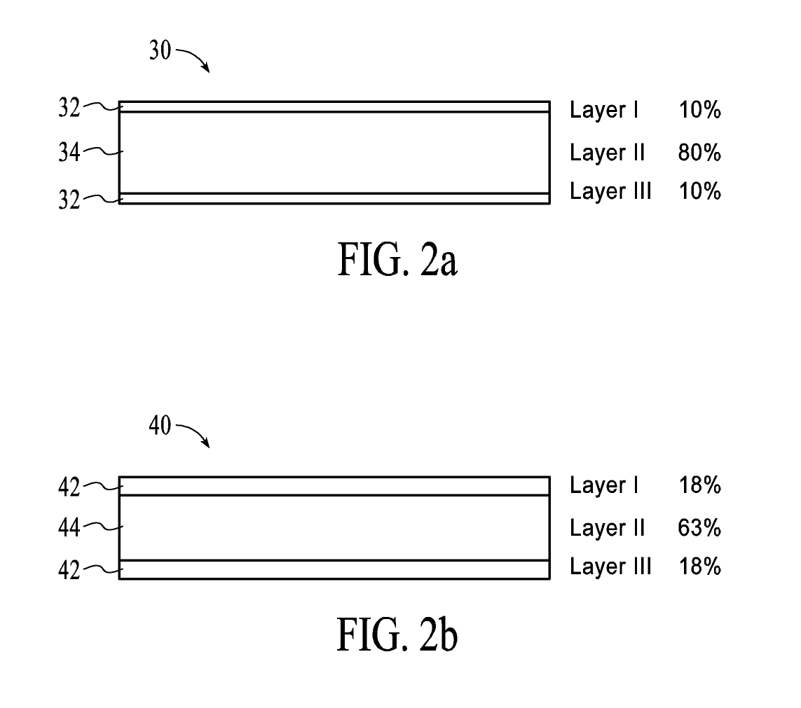

In FIGS. 2a and 2b there is in each case a cross-section of a film 30, 40 that has been extruded according to embodiments of the method of the invention, or alternatively of a container wall 52 of a packaging container according to embodiments of the invention with three layers. The internal layer 34, 44 is in each case made up of foamed plastic material and features a greater thickness than the two outer surface layers 32, 42.

The plastic film depicted in FIG. 2a is created from PET, whereas the plastic film depicted in FIG. 2b is created from PS or PP. In the case of the plastic film created from PET of FIG. 2a, the foamed internal layer features approximately 80% of the total thickness of the plastic film and each of the outer layers feature approximately 10% of the total thickness. The thickness of the internal layer is approximately 0.48 mm and the thicknesses of the two outer layers are each about 0.06 mm.

In contrast, the foamed internal layer of FIG. 2b, that is created from PS or PP, features approximately 63% of the total thickness of the plastic film. The greater density of the PET in contrast to the density of PS and PP is one of the reasons for this different thickness, so that it is desirable to use an especially great thickness of the (lighter) foamed layer for the purpose of weight-saving in the packaging container when using PET. It has namely been demonstrated that the solidity of the container wall, notwithstanding the foaming, is not affected when using a like total thickness due to the honeycomb structure of the foamed plastic material. On the other hand, when using PS or PP it can be desirable to use a greater thickness of the non-foamed outer surface layers, given the already lesser weight of this plastic material.

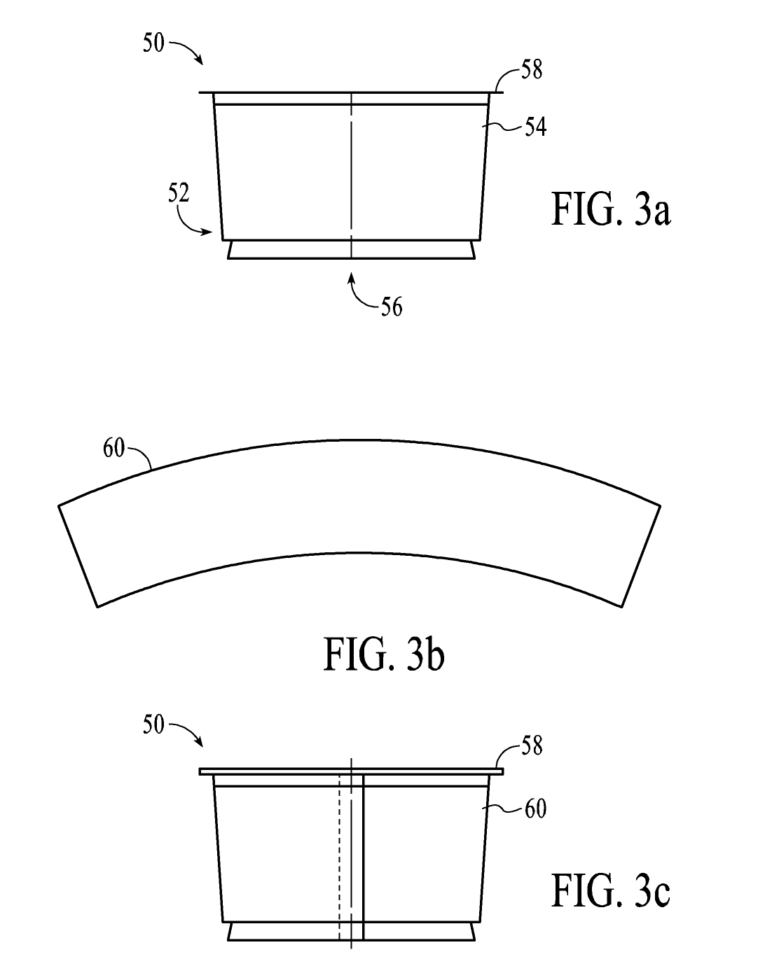

In FIG. 3a there is the depiction of a packaging container 50 according to embodiments of the invention with a container base 56 and a container shell 54 that creates the lateral boundary of the container. The packaging container 50 is a plastic cup used to contain foodstuffs such as for example dairy products. The container base and the container shell are made of a partially foamed plastic film, as is for example depicted in FIG. 2 and are thereby at least partially created from a foamed plastic material. It has been shown that PET is an especially appropriate plastic material in this context, polystyrene and/or polypropylene can however be used in an advantageous manner. This insofar as PP and PS have lesser densities than PET, and the packaging containers that are produced from them are thus especially lightweight.

The container wall 52 of the cup should be especially solid in the area of the seal edge 58, so that no damage to the cup is incurred when the force is exercised on the seal edge when opening the cup. A partially foamed container wall 52 in this area offers this necessary solidity.

The solidity of the packaging container is further increased when the container shell is circumferentially reinforced by means of a sleeve 60. The sleeve can be made out of a flat fold-out sheet as depicted in FIG. 3b. Paper and/or cardboard have been shown to be especially advantageous materials for the sleeve. The paper can be printed with labels, images or similar and/or coated on one or both sides for protection against humidity.

The fold-out sheet can be provided with adhesive material on a lateral edge and can then be fitted to the packaging container to create the sleeve around the container shell, whereby the two overlapping lateral boundaries of the fold-out sheet create an overlapping seam. Furthermore containers and sleeves can be glued and/or sealed to one another in a detachable manner. In this manner the user can remove the sleeve that is generally made of paper from the container made of plastic material and can dispose of both parts separately. The glue can for example be pre-dried with a hot-air jet following application. The sleeve can be pressed by closure cups onto the container that is pinned on a dome, in such a manner that the overlap seam is created on which the two lateral edges of the sleeve are glued or sealed in an overlapping manner with one another. Subsequently a lower edge of the sleeve can be flanged all around in an inward direction to the container base according to the layout.

Upon placement of the sleeve, the solidity of the packaging container is increased. For this reason it is possible to keep the thickness of the container wall of a packaging container produced according to embodiments of the invention especially limited and the use of plastic material can thereby be further minimized.

Furthermore the container base can be reinforced by a base part (not shown) that is preferably at least partially laid up against the container base. The base part can for example be stamped out from a material web, from which the sleeve is also produced, and be glued or sealed to the container base. Alternatively or additionally it is possible to foresee the attachment of the base part to the sleeve. For this it is for example possible to flange an edge of the base part inwards. Thereafter the cup can be fed to a rolling tool in which the definitive bond between the container, sleeve and base part is created and in which the container receives its definitive shape in the base area.

The packaging container according to embodiments of the invention is not limited to the described embodiment. Rather, it is evident to the person skilled in the art that an otherwise shaped and/or a packaging container featuring a container wall with fewer or more layers achieves the suitable effect, and the mentioned solidity advantages can be gained. A further coating or painting/gluing of the container wall is also conceivable.

1. A method for the production of a packaging container, in which a plastic raw material is melted and extruded to obtain a plastic film, that is subsequently further processed into a packaging container in a forming process characterized by at least one part of the plastic raw material having a propellant added prior or during the extrusion stage in such a manner that leads to the expansion upon its exit from the extrusion die of the extrudate that has had the propellant added, or should the occasion arise upon release of a propellant.

2. The method of claim 1, wherein the plastic raw material includes polyethylene (PET).

3. The method of claim 1, wherein the propellant includes citric acid and/or sodium hydrogen carbonate.

4. The method of claim 1, wherein the plastic film is multilayered and is formed by a co-extrusion method.

5. The method of claim 1, wherein the forming process includes a deep-drawing process or a thermoforming process.

6. The method of claim 1, further comprising a sleeve fitted to the packaging container subsequent to the forming process in such a manner that the sleeve is laid up at least partially against an outer surface of a container wall and reinforces the same.

7. The method of claim 6, wherein the sleeve is glued or sealed in a detachable manner to the container wall.

8. The method of claim 6, further comprising a base part that is laid up against the container base of the container and bound to the sleeve by the flanging of the lower edge of the sleeve.

9. A packaging container formed using the method of claim 1.

10. The packaging container of claim 9, wherein the plastic material is polyethylene terephthalate (PET).

11. The packaging container claim 9, wherein the container wall is at least partially multi-layered.

12. The packaging container of claim 11, further comprising an internal layer of the container wall featuring a lesser geometric density than that of the layers that surround the internal layer, in particular than the outer surface layers of the container wall.

13. The packaging container of claim 11, wherein an internal layer of the container wall is made up of a foamed plastic material and the outer surface layers of the container wall being preferably made up of non-foamed plastic material.

14. The packaging container of claim 11, wherein the thickness of the foamed layer is between 50% and 90% of the total thickness of the container wall.

15. The packaging container of claim 11, wherein an internal layer of the container wall has a thickness in the range of 0.1-1 mm, and the outer surface layers of the container wall has a thicknesses in the range of 0.01-0.1 mm.

16. The packaging container of claim 11, wherein all layers of the container wall are at least partially made up of PET.

17. The packaging container of claim 11, wherein one foamed layer of the container wall has a geometric density in the range of 0.5-1.2 g/cm³.

18. The packaging container of claim 9, wherein the packaging container is a plastic cup configured to contain a dairy product.

19. The packaging container of claim 9, wherein the container wall includes a seal edge that is attached to the side opposite to the container base and approximately parallel to the container base.

20. The packaging container of claim 9, wherein the plastic material is polystyrene (PS) and/or polypropylene (PP).

21. The packaging container of claim 9, further comprising a sleeve that is at least partially laid up against the container wall and reinforces the container wall.

22. The packaging container of claim 21, wherein the sleeve stretches continuously from the container base to the seal edge and at least partially enclosing the container shell in a pipe-like manner.

23. The packaging container of claim 21, further comprising a base part that is reinforced and is at least partially laid up against one outer surface of the container base and is connected to the sleeve.

24. The packaging container of claim 21, wherein the sleeve and/or the base part comprises coated and/or printed cardboard or paper.

25. The packaging container of claim 9, further comprising a container base and a container wall created by a container shell constructed by the lateral boundary of the container, wherein the container wall is at least partially created from foamed plastic material.

26. The packaging container of claim 14, wherein the thickness of the foamed layer is 80% of the total thickness of the container wall.

27. The packaging container of claim 15, wherein the internal layer of the container wall has a thickness of 0.48 mm and the outer surface layers of the container wall has a thicknesses of 0.06 mm.

28. The packaging container of claim 17, wherein the one foamed layer of the container wall has a geometric density in the range of 0.8-1 g/cm³.
